(19) United States
(12) Patent Application Publication
(10) Pub. No.: US 2007/0067726 A1
(43) Pub. Date: Mar. 22, 2007

(54) CONTENT SHARING USER INTERFACE FOR MOBILE DEVICES

(75) Inventors: David W. Flynt, Lake Forest Park, WA (US); Bryan T. Agnetta, Seattle, WA (US); Sally Louise Barton, Seattle, WA (US); Peter G. Chin, Seattle, WA (US); Vinoo Cherian, Kirkland, WA (US); Timothy James Benton, Kirkland, WA (US); Eduardo Escardo-Raffo, Seattle, WA (US); Ardan Arac, Seattle, WA (US); Shashank Gupta, Bellevue, WA (US); Keith Campbell Bentley, Redmond, WA (US)

Correspondence Address: AMIN. TUROCY & CALVIN, LLP, 24TH FLOOR, NATIONAL CITY CENTER, 1900 EAST NINTH STREET, CLEVELAND, OH, 44114, US

(73) Assignee: MICROSOFT CORPORATION, Redmond, WA (US)

(21) Appl. No.: 11/424,706

(22) Filed: Jun. 16, 2006

Related U.S. Application Data
(60) Provisional application No. 60/718,187, filed on Sep. 16, 2005.

(51) Int. Cl. G06F 3/00; G06F 17/30

(52) U.S. Cl. 715/733; 707/3

(57) ABSTRACT

The subject disclosure pertains to systems and methods for providing an improved user interface for mobile devices. A user interface can obtain content including data and associated tasks from a set of software applications. Consequently, users can access content from multiple applications without navigating away from the user interface. The system architecture is extensible, providing for the addition of applications and user interfaces without requiring modification of the existing applications or user interfaces. Applications can register data suppliers capable of retrieving data from the underlying data store for the application and task executors capable of acting on the data. A user interface can generate a query requesting a class of data and specifying a context used to filter possible results. The system can determine the appropriate data suppliers, distribute queries and return the assembled results to the user interface.

### CROSS-REFERENCE TO RELATED APPLICATIONS

This is an application claiming benefit under 35 U.S.C. 119(e) of U.S. Provisional Patent application Ser. No. 60/718,187 entitled “ENHANCED PORTABLE DEVICE NAVIGATION TOOLS” and filed Sep. 16, 2005. This application is also related to co-pending U.S. patent application Ser. No. ______, (Atty. Docket No. MS315059.01/MSFTP1352US), entitled, “SEARCH INTERFACE FOR MOBILE DEVICES”, and filed ______; U.S. patent application Ser. No. ______, (Atty. Docket No. MS315060.01/MSFTP1309US), entitled, “EXTENSIBLE, FILTERED LISTS FOR MOBILE DEVICE USER INTERFACE”, and filed ______; and U.S. patent application Ser. No. ______, (Atty. Docket No. MS315063.01/MSFTP1355US), entitled, “TILE SPACE USER INTERFACE FOR MOBILE DEVICES”, and filed ______. The entireties of the above-noted applications are incorporated by reference herein.

### BACKGROUND

Mobile or portable devices have become increasingly popular and prevalent in today's society. Many users utilize a mobile device, such as a cell phone, as their primary means of communication and carry such devices with them constantly. Mobile devices can include multiple functions such as cellular phone service, voice over Internet protocol (“VoIP”) phone service, software applications, email access, Internet capabilities, calendar functions, music players and the like. Functions, features and capabilities have increased both the utility and complexity of mobile devices. It is likely that functions will continue to be added to mobile devices further increasing both usefulness and intricacy.

While consumers desire additional functionality, the sheer volume of information and features make it difficult for users to access commonly used data and functions. Mobile device complexity also makes it difficult for users to fully exploit the capabilities of such devices. The problem is exacerbated by the generally limited user interfaces of mobile devices. Such devices are designed to be small, lightweight and easily portable. Consequently, mobile devices typically have limited display screens, keypads, keyboards and/or other input devices. Due to the size of the user input devices and display screens, it may be difficult for users to enter, retrieve and view information.

Users may have difficulty in accessing the information or function they desire due to organization of the volume and variety of information that may be contained in or accessed by the mobile device, as well as the growing number of functions such devices are capable of supporting. Conventional menu structures for mobile devices require users to remember a hierarchy of functions or applications to reach the desired data or task. Information is frequently organized based upon the application software that provides or manages a particular type of information. Consequently, users can be required to access information based upon the various software applications rather than based upon user utility. Users can become frustrated when they are unable to locate the desired information or tasks and may be unable to fully exploit the functions and advantages of the mobile device.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns an improved user interface for mobile devices such as smartphones, personal digital assistants (PDAs) and the like. Systems and methods for providing for transfer of content such as data and tasks from one or more applications to one or more clients or user interfaces are described herein. The transfer of content allows a single, central user interface to provide a user with access to data and tasks from multiple software applications. A user can access the supplied content without navigating away from the central user interface. The sharing of content from multiple applications provides the basis for a user interface based upon data relationships and user context, rather than individual software applications.

The system architecture can be extensible, allowing for the addition of both clients and applications without requiring modification of existing clients and applications. The system can provide a standard interface between clients and applications providing content, such that clients need not have knowledge of the underlying data structures or even the identity of applications. Applications can register new categories or classifications of data and tasks with the system, automatically allowing the user interface to access the additional data and tasks. Applications can provide data supplier components capable of retrieving data items from the underlying data store of the application. In addition, applications can provide one or more task executors capable of executing actions or tasks on data items of selected data types or categories.

Clients can obtain data and associated tasks by generating a query that can specify the category of data requested as well as context used to identify relevant data of the requested category. A set of data requests based upon the query from a client can be distributed to selected data supplier components. The data supplier components can retrieve the relevant data from the underlying data stores of associated applications. The retrieved results can be assembled and returned to the client in response to the initial query. The query, data requests and query results can be specified in a declarative language, such as extended markup language (XML) to facilitate transfer of data without requiring knowledge of data structures by the client.

The system can also provide additional utilities to allow clients to utilize the query results without requiring knowledge of the underlying data structures. For instance, the system can include a utility capable of sorting query results based upon a property associated with the type or category of result. The system can also include a utility capable of rendering query results on a display screen based upon display properties associated with the type of data of the query results. In addition, the system can provide a utility capable of parsing the query results and returning specific data items to clients.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a system for sharing content from one or more software applications in accordance with an aspect of the subject matter disclosed herein.

FIG. 2 is a block diagram of a system for sharing content from one or more software applications in accordance with an aspect of the subject matter disclosed herein.

FIG. 3 is a block diagram of a system for sharing content from one or more software applications in accordance with an aspect of the subject matter disclosed herein.

FIG. 4 illustrates exemplary user interfaces in accordance with an aspect of the subject matter disclosed herein.

FIG. 5 is a block diagram of a system for sharing content from one or more software applications in accordance with an aspect of the subject matter disclosed herein.

FIG. 6 illustrates a methodology for retrieving relevant content from one or more applications in accordance with an aspect of the subject matter disclosed herein.

FIG. 7 illustrates a methodology for identifying supplier components in response to a query in accordance with an aspect of the subject matter disclosed herein.

FIG. 8 illustrates a methodology for preparing query results for display in accordance with an aspect of the subject matter disclosed herein.

FIG. 9 illustrates a methodology for retrieving tasks associated with a data item in accordance with an aspect of the subject matter disclosed herein.

FIG. 10 illustrates a methodology for adding a new application in accordance with an aspect of the subject matter disclosed herein.

FIG. 11 is a schematic block diagram illustrating a suitable operating environment.

FIG. 12 is a schematic block diagram of a sample-computing environment.

### DETAILED DESCRIPTION

The various aspects of the subject matter described herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

As used herein, the terms “component,” “system” and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on computer and the computer can be a component. One or more components may reside within a process and/or thread of execution and a component may be localized on one computer and/or distributed between two or more computers.

The word “exemplary” is used herein to mean serving as an example, instance, or illustration. The subject matter disclosed herein is not limited by such examples. In addition, any aspect or design described herein as “exemplary” is not necessarily to be construed as preferred or advantageous over other aspects or designs.

Furthermore, the disclosed subject matter may be implemented as a system, method, apparatus, or article of manufacture using standard programming and/or engineering techniques to produce software, firmware, hardware, or any combination thereof to control a computer or processor based device to implement aspects detailed herein. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD). . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Content on mobile devices can take many forms including, but not limited to, contact information, calendar items, mail, music, photos, documents, and tasks. A task is any action that can be carried out on any data item. For example, for a data item such as a phone number, a task for calling the phone number can be associated with the data item. Tasks can be used to populate menus for a data item or mapped to hardware actions such as push buttons. Access to content including data and available tasks is typically provided only through software applications specific to the data type of the content, such as an application used to create or render the specific content data type. For example, to read email from an individual, a user may be required to navigate to and open an email application. To call that same individual with a question regarding that email, the user may be required to navigate to the space where that individual's communication details are visible (e.g., a contact card specifying contact specific information). Finding relevant information can require first determining the appropriate software application, opening the application and searching for the relevant information within the application. For example, to view mail from a specific sender, the user may be required to navigate to an email application and search within the email application using the sender's name.

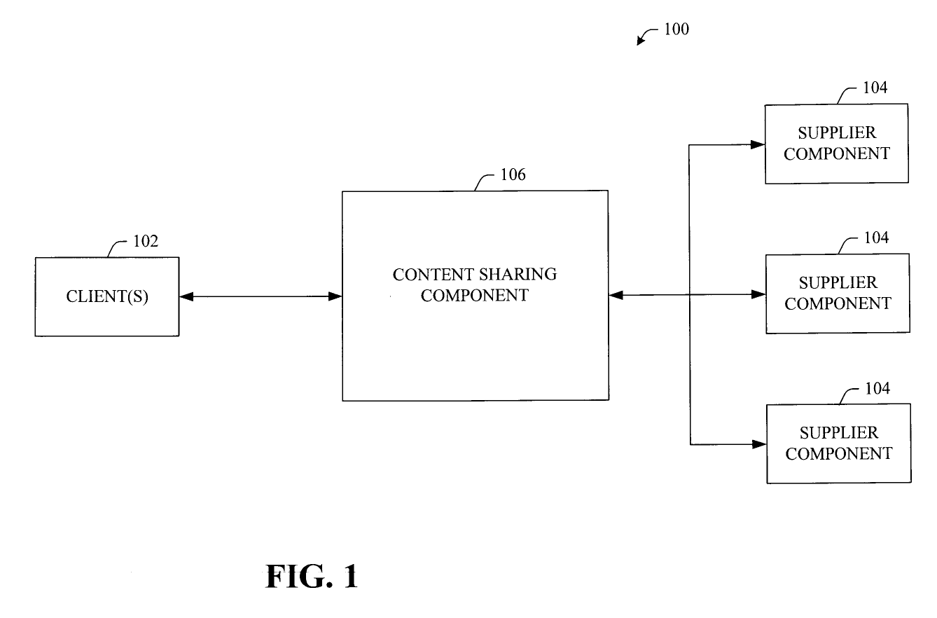

Referring now to FIG. 1, a system 100 for searching and retrieving content from one or more software applications is illustrated. The system includes one or more clients 102 that can utilize retrieved content, one or more supplier components 104 associated with applications that provide content and a content sharing component 106 that provides an interface between client(s) 102 and supplier component(s) 104. Clients 102 can include any application, user interface or other component capable of utilizing the provided content. The content sharing component 106 can provide a standardized interface that allows clients 102 to access content, including data and tasks, provided by supplier components 104, without requiring clients 102 and supplier components 104 to interact directly. The content sharing component 106 allows clients 102 to request data or tasks without the necessity of knowledge of the supplier components 104 or the underlying format of the data within the supplier components 104. Queries from clients 102 can be used to generate queries or requests that are distributed to one or more supplier components 104 registered with the content sharing component 106. Results of the supplier component 104 queries can be compiled by the content sharing component 106 and provided to the client 102.

A supplier component 104 can provide access to data and/or tasks of an application (not shown) or a subset of such data and/or tasks. Supplier components 104 can search a particular database or data store of an application based upon a received query. Supplier components 104 can also perform operations to access a remote network or other data sources (e.g., the Internet) to retrieve information.

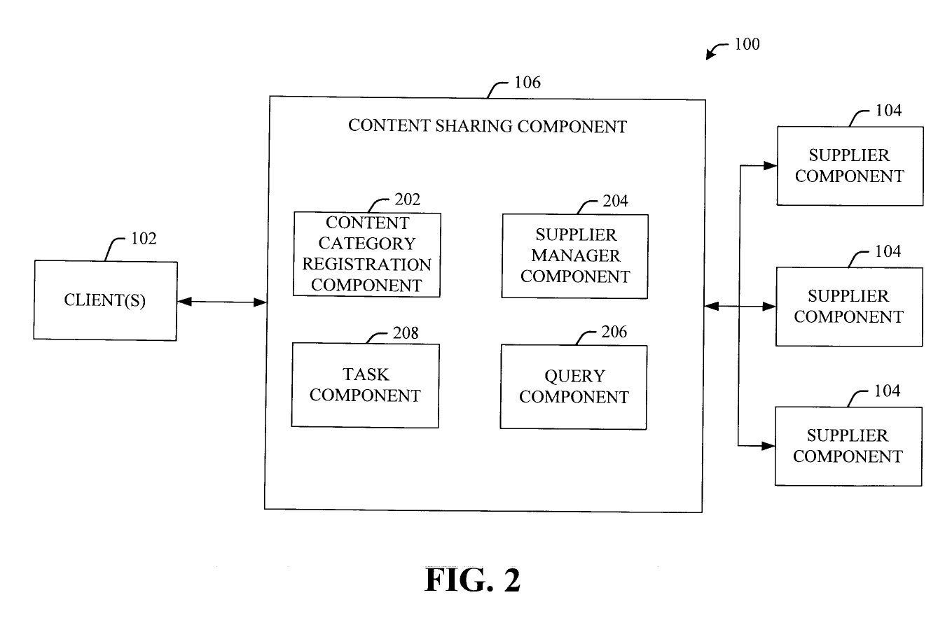

FIG. 2 is a more detailed illustration of a system 100 for sharing content from one or more applications. The content sharing component 106 includes a content category registration component 202, a supplier manager component 204, a query component 206 and a task component 208. The content category registration component 202 manages a set of content categories used to represent categories or classes of data. A content category can be a placeholder without a set or defined data structure. The content category can include a simple, unique identifier such as a text string (e.g., “Contact”). In addition, a content category can be an aggregate of several categories. For instance, the Contact category can include a Name category and a Phone-number category. For clarity, content categories are capitalized herein. The terms “content category” and “category” can be used interchangeably herein.

Content categories can have associated tasks, properties and relationships. Content category properties can provide information related to a category, such as a display property that specifies the format in which the category should be rendered for display (e.g., single line of text or icon). Properties can also include a sort property that specifies an order in which to sort items (e.g. alphabetical). The sort property can identify a category or data within the parent category to be used to determine order. For instance, the Contact content category can be sorted based upon Name.

Relationships between content categories can be maintained and managed by the content category registration component 202. Relationships indicate how the categories are connected or associated and can be utilized to provide clients 102 with relevant content. The subcategory relationship is one possible relationship between categories. For content categories “A” and “B” if A is a subcategory of B, content category B acts as a more general classification that includes content category A. For example, Phone can include the Mobile Phone category. If A is a subcategory of B, content category A will inherit tasks and properties associated with content category B, unless content category A specifically overrides those tasks and properties. In addition, if a query is requested for data of content category B, items of content category A can also be queried, as discussed in detail below. The content category registration component 202 can also provide for multiple relationships and inheritance. A content category can inherit from multiple categories. For example, for content categories “A”, “B” and “C”, A can inherit from both B and C, such that A is a subcategory of B and A is a subcategory of C. However, circular relationships can be problematic and may not be permitted. For example, if A is a subcategory of B and B is a subcategory of C, C cannot be a subcategory of A.

The content sharing component 106 can also include a supplier manager component 204 that can handle registration of supplier components 104 of one or more software application. The system 100 is extensible, allowing for the addition of clients 102 and supplier components 104. During registration, supplier components 104 can identify the types of queries (e.g., the requested category and filter category) that the supplier component 104 supports. Query type can be defined based upon a requested category of content and a filter category used to retrieve results, as discussed in detail below. Supplier component registration can be updated at anytime to reflect changes to types of queries supported by the supplier component 104. The supplier manager component 204 can identify different supplier components 104 to be queried based upon query type of a client query and the query types supported by the supplier component 104 and for which the supplier component 104 has registered.

The content sharing component 106 can include a query component 206 that handles queries from one or more clients 102. The query component 206 can receive a query from a client 102 including a requested category and context used to filter available content and identify relevant data and tasks. The supplier manager component 204 can provide the query component 206 with information regarding the appropriate supplier components 104 based upon query type of the client query and query types supported by the supplier components 104. The query component 206 can distribute a query based upon the client query to each of the appropriate supplier components 104. The results received from the supplier components 104 can be assembled before being returned to a client 102.

The task component 208 can create and manages a list of tasks associated with each content category registered with the content category registration component 202. For instance, an Email Address content category can have an associated send email task for sending an email to the email address. A task can include a unique identifier to identify the task, a task executor that executes the task and a name or label that can be displayed on a user interface to allow users to select the task. For instance, a user interface can provide users with a menu including labels for each task associated with the content category. The task component 208 can manage a set of task executors that perform actions associated with specific tasks. Supplier components 104 can register tasks provided by the associated applications with the task component 208. In addition, query results from a supplier component 104 can include specific tasks associated with a data item. Clients can utilize the task component 208 to determine tasks associated with a specific query result, including a task executor that executes the task or action.

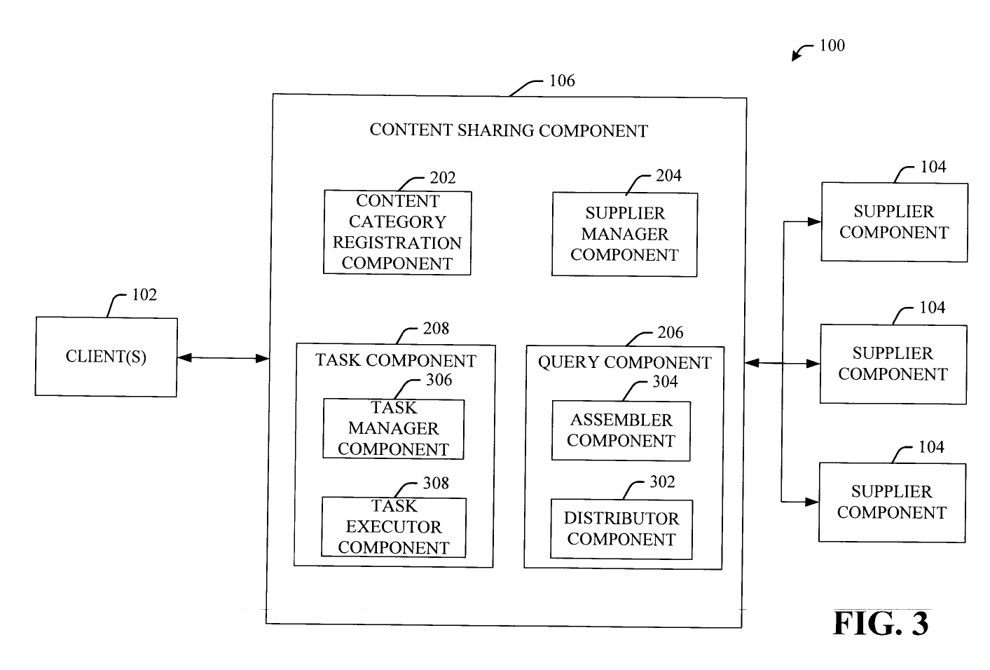

Referring now to FIG. 3, the query component 206 and task component 208 are illustrated in further detail. The query component 206 can include a distributor component 302 and an assembler component 304. The distributor component 302 can determine which, if any, of the supplier components 104 can handle a given query. The distributor component 302 can generate a set of queries or data requests and initiate a search of one or more supplier components 104 based upon a query received from a client 102. The distributor component 302 can expand or generalize a query based upon content category relationships. Results from multiple supplier components 104 can be aggregated by the assembler component 304 and the total results can be provided to the client 102 that generated the client or master query.

A client query can include a requested category, a filter category, filter data and a batch size. The requested category can indicate the content category of the content requested by the client 102. The filter category and filter data can specify context used as a filter for the query. The filter category indicates the content category of data to be used as a filter and filter data indicates the actual data compared to content to generate search results. Batch size can indicate a maximum number of results to return. Batch size can be used to limit searches, thereby avoiding excessive delays and ensuring adequate performance. Once the number of results requested has been located as specified by batch size, execution of the query can be suspended. Queries can be specified using a declarative language (e.g. XML). Consider the following exemplary query:

<requested-category>Contact</requested-category>
<filter><Phone-number>425-555-1234</Phone-number></filter>
<Batch-size>1</Batch-size>

Here, the query requests a search for an individual or entity, referred to herein as a contact, with phone number (425) 555-1234. Batch size is set to one; indicating that only one result is desired. In the example, the requested category is Contact, the filter category is Phone-number, and the filter data is the specific phone number of the contact.

The query context or filter can be an aggregate of several data items. Consider the following exemplary query:

```
<requested-category>Message</requested-category>
<filter>
  <Contact>
    <Phone-number>425-555-0234</ Phone-number>
    <Email-address>test@anyaddress.com</Email-address>
  </Contact>
</filter>
<Batch-size>20</Batch-size>
```

Here, the query includes a request for a search for messages from a contact with email address test@anyaddress.com or phone number 425-555-0234. A Contact category filter uses filter data including a specified phone number and a specified email address. In addition, query result items returned from a previous query can be used as the filter context for a new query. In the example above, the contact filter can be a result of a prior query returned by the content sharing component 106.

Client queries can be interpreted by the distributor component 302 and used to generate and distribute separate queries or perform searches using individual supplier components 104 registered with the supplier manager component 204. At registration, supplier component 104 can specify the types of queries that the supplier component 104 can handle. Query type can be defined based upon the combination of requested category and filter category. When a query is received, the distributor component 302 can determine which, if any, of the supplier components 104 registered with the supplier manager component 204 can support the received query. The distributor component 302 can copy the client query to distribute queries to each supplier component registered with the supplier manager component 204 that supports the query type of the query received from the client 102.

The distributor component 302 can also utilize content category relationships to identify supplier components 104 capable of providing relevant data where the query type supported by the supplier component is not an exact match to the query type of the client query. The distributor component 302 can distribute queries to any supplier component where content category provided by the supplier component is a subcategory of the requested category of client query. For example, a client can generate a query, with a requested category of Email Message. A specific supplier component 104 can support queries with a requested category of Hotmail Email Messages and filter category of Contact, where the Hotmail Email Message category is a subcategory of Email Message. The distributor component 302 can generate and distribute a query to the specific supplier component 104 because the supplier component 104 can return content for a subcategory of the requested category.

The distributor component 302 can also utilize data relationships to generalize filter categories and identify additional supplier components 104. For example, a query can include a requested category “Email Message”, filter category “Business Contact” and filter data “Joe Smith.” The query can be distributed to a supplier component 104 that supports queries with a requested category of Email Message and a filter category of Contact, where a Business Contact is a subcategory of Contact. The distributor component 302 can generate and distribute a separate query based upon the client query where the filter category of the client query is a subcategory of the filter category used by the supplier component 104. However, generalization of filter categories can be limited to those instances in which no supplier components 104 are otherwise identified that support the query type of the query. Generalization of filter category can potentially yield data outside the intended context. In the example, if there were two contacts named “Joe Smith” in the address book, one a business contact, the other a personal friend, the supplier component 104 may return email messages from the friend in addition to the those of the business contact. Typically, the generalization of filter category can be avoided; however, if no supplier components 104 are otherwise identified, the distributor component 302 can utilize supplier components 104 that support a generalized filter category. Such supplier components 104 have at least the potential to locate matches for the actual filter category.

The task component 208 can include a task manager component 306 and a task executor component 308. The task manager component 306 can maintain a list or set of tasks associated with content categories as maintained by the content category registration component 202. As supplier components 104 are added to the system 100, the supplier components 104 can dynamically register additional tasks with the task manager component 306. In addition, the task manager component 306 can merge and prioritize tasks associated with content categories as maintained by the content category registration component 202 and tasks returned by supplier components 104 in query result items. Tasks returned in a query result can be prioritized over tasks associated with a content category. The task executor component 308 can maintain a set of task executors associated with tasks. The task executors are capable of executing the task with which they are associated.

The task manager component 306 can also determine whether a task should be propagated across multiple content categories. For example, if a content category A includes a task propagation property that specifies that tasks associated with content category B should be propagated for content category A, then when a client 102 requests tasks associated with content category A, the task manager component 306 will also return tasks associated with content category B. For instance, the Contact category can include a task propagation property that specifies that tasks for the Phone Number category should be propagated to Contact category objects. Consider the following query results:

```
<Contact>
  <Phone-number>5556984</Phone-number>
  <Name>Finnegan</Name>
</Contact>
```

Here, a Contact is returned including a Phone Number and Name. The tasks registered for Phone numbers, such as “Call” or “Send Text Message” can be automatically propagated to a menu of tasks for that Contact item by the task manager component 306. Query results can be assembled in a query result list by the assembler component 304 and provided to a client 102. The client 102 can include a user interface display for a mobile device and query results can be rendered to the user interface display. When an object or data item is selected in the user interface, a menu including text labels for tasks associated with the object can be displayed. The client 102 can provide the task manager component 306 with a handle to the menu to be populated with the appropriate task labels by the task manager component 306. The client 102 can provide the task manager component 306 with the opportunity to pre-fetch task executors that correspond to the selected item. In addition, the client 102 can specify a maximum number of tasks to be included in the menu. The task manager component 306 can prioritize the tasks associated with the query result or item and list tasks in the prioritized order. The client 102 can also prioritize the tasks and add additional tasks. If a menu item is selected by a user (and the item was populated by the task manager component 306), the client 102 can prompt the task manager component 306 to execute the task, and the task manager component 306 can notify the appropriate task executor.

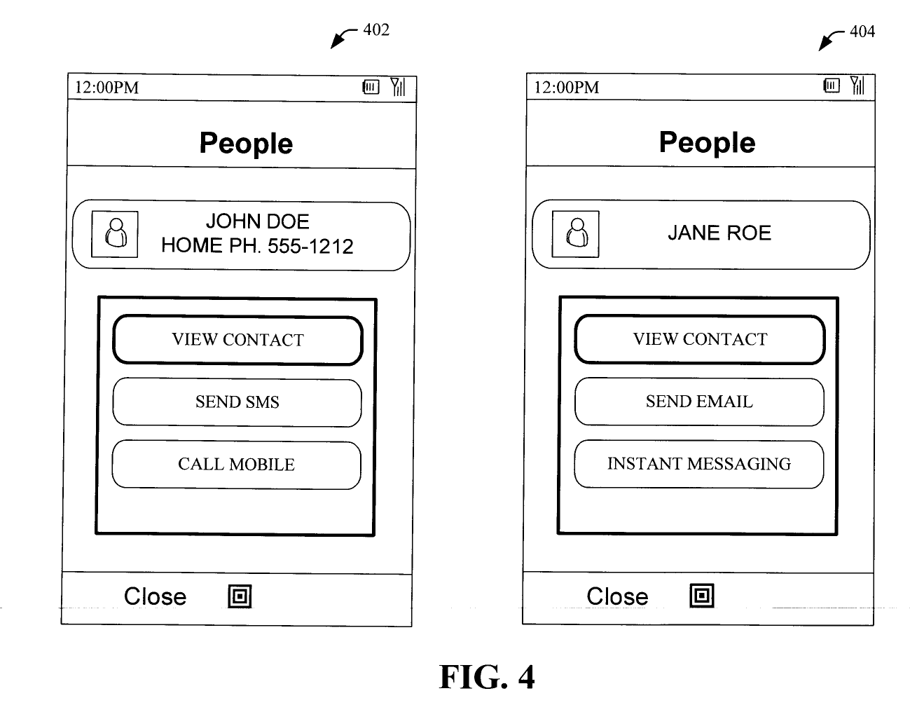

Referring now to FIG. 4, exemplary client user interface displays are illustrated. In a first display screen 402, the contact labeled “John Doe” has been selected and a menu listing possible tasks associated with the selected contact is displayed. The default task or action can be highlighted. In exemplary display screen 402, the default task provides a more detailed view of the contact. Additional tasks can provide the user with the ability to send a short message service (SMS) message or to call the mobile phone of the contact. The tasks displayed in the menu can be based not just on the category of data selected (e.g., a Contact), but on the particular instance of the contact. For example, in the second display screen 404, a second contact labeled “Jane Roe” is selected. Once again a set of tasks or actions associated with the contact are displayed. However, because contact information for Jane Roe does not include a mobile phone number, the associated list of tasks does not include an action for calling the mobile phone. Instead, the task list includes alternative actions such as sending an email or using instant messaging to reach the contact. As shown in the example user interfaces, the display can be updated not just based upon the category of data displayed, but the actual instance of data.

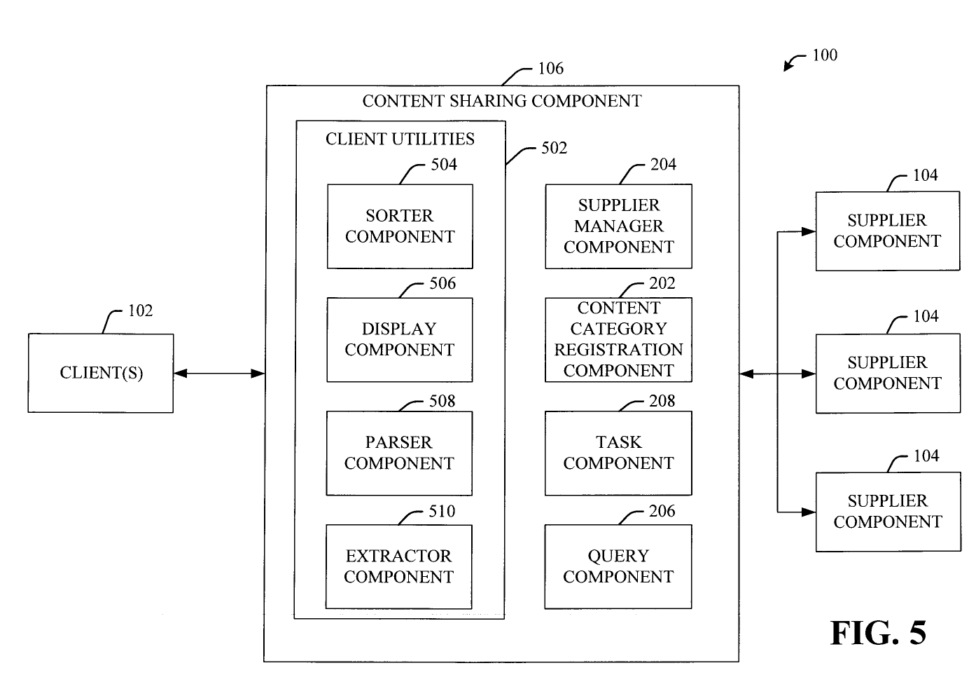

Referring now to FIG. 5, the system 100 can include a set of client utilities 502 that provide services for one or more clients 102. Client utilities 502 can enable clients 102 to utilize content provided by the system 100 without knowledge of the underlying data structures. The client utilities 502 can include a sorter component 504, a display component 506, a parser component 508, and an extractor component 510. The sorter component 504 can sort or order the query results and return the sorted results to the client 102. To support sorting, content categories can include a sort property that specifies data used to sort query results and comparison modules used to sort results.

The display component 506 can provide clients 102 with the ability to display query results in the appropriate format without requiring the client 102 to have knowledge of the display features of each category. Each category can include a display property that defines how the category is to be displayed. For example, the display property can specify how the item of that category should be displayed in a single line in a list, in a double line in a list or as an icon. The display component 506 can retrieve the display property from the query result and render the item based upon the display property. For example, the display property for unread message items can indicate that the item should appear in bold font. The display component 506 can ensure that the item is correctly displayed without requiring the client 102 to be aware of display formats for a set of content categories. This allows for the addition or modification and display of content categories without requiring modification of the client 102.

The parser component 508 can provide a client 102 with information parsed from the query result. Query results can be returned by supplier components in a declarative language, such as XML. The parser component 508 can parse the query result and return desired data to the client 102. Consider the following exemplary query result:

```
<Contact>
  <Name>Flanagan</Name>
  <Phone>453 985932</Phone>
  <task><task-id>FindMap</task-id>...</task>
  <task><task-id>DoSomething</task-id>...</task>
  <source>
    <source-id>POOM</source-id>
    <item-id>1239084</item-id>
  </source>
</Contact>
```

If a client 102 requests the contact name, the parser component 508 can return the text string “Flanagan” or a pointer to the string “Flanagan.” If the client 102 requests tasks associated with the contact, the parser component 508 can return pointer to the “FindMap” and “DoSomething” tasks.

The parser component 508 can also utilize content category relationships to provide data to the client 102. If the content category of the data requested has one or more subcategories, the parser component 508 can return data from subcategories of the data. For instance, if the client requests data for a Phone, the parser component can return Phone, HomePhone data or MobilePhone data, where both HomePhone and MobilePhone are subcategories of Phone.

The extractor component 510 can be utilized with the parser component 508 to provide data to clients 102 based upon query results. To reduce the amount of data passed from supplier components 104 through the content sharing component 106 to clients 102, supplier components 104 can register with the extractor component 510. In this case, the query result would consist only of source specific information with each data item. For the exemplary query result described above, the result would be reduced to the following:

```
<Contact>
  <source>
    <source-id>POOM</source-id>
    <item-id>1239084</item-id>
  </source>
</Contact>
```

Here, the source identifier is POOM and the item identifier is 1239084. If the client 102 requests data such as a Task or Phone, the parser component 508 can determine if the data was returned within the query result. If the query result contained the data, the parser component 508 can return the data or a pointer to the data to the client 102. However, if the data is not included within the query result, the parser component 508 can determine if the source was registered with the extractor component 510. If the source is registered with the extractor component 508, the parser component 508 can pass the source and item identifiers to the extractor component 510. The extractor component 510 can then retrieve the desired information directly from the supplier component 104. By transferring only data specifically requested by the client 102, the amount of data transferred is minimized.

The aforementioned systems have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Additionally, it should be noted that one or more components may be combined into a single component providing aggregate functionality or divided into several sub-components. The components may also interact with one or more other components not specifically described herein but known by those of skill in the art.

Furthermore, as will be appreciated various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent.

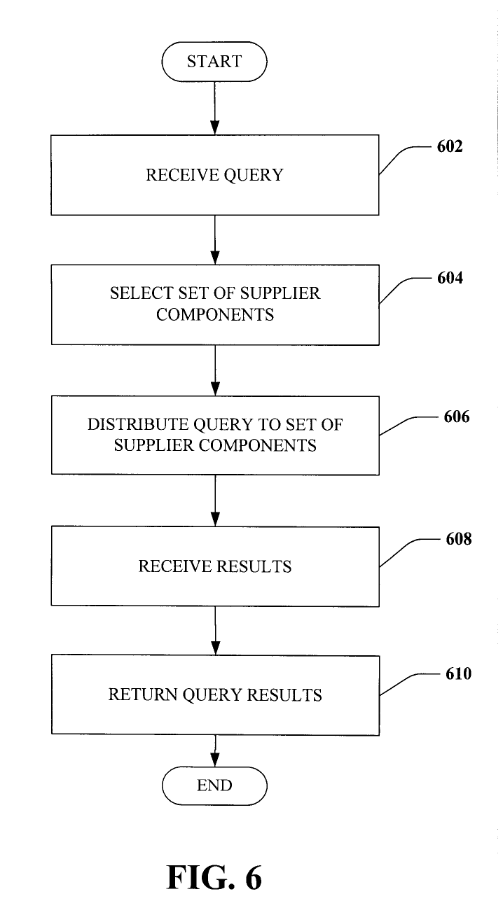

In view of the exemplary systems described supra, methodologies that may be implemented in accordance with the disclosed subject matter will be better appreciated with reference to the flowcharts of FIGS. 6-10. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, carrier, or media.

Referring now to FIG. 6, a methodology for retrieving content from one or more applications is illustrated. At reference numeral 602, a client query is received. The query can request information of a specific content category such as Contacts, Messages, Documents, Audio Files and the like. The query can also specify a context to be used as a filter when retrieving data in response to the query. The context can include a specific item of data (e.g., 555-1212), and the category of the specific item (e.g., Phone Number). In addition, the query can include a limitation on the number of results to be returned in response to the query.

At reference numeral 604, a set of supplier components can be selected in response to the query. The set of supplier components can include any number of supplier components that support the query type. A supplier component can register query types that it is capable of supporting. The register of supplier components can be searched to determine the supplier components to select based upon the client query. A query based upon the client query is distributed to each of the selected set of supplier components at reference numeral 606. Queries can be individualized for the particular supplier components. The distributed queries can also specify a maximum number of results to be returned.

At reference numeral 608, results can be received from the set of supplier components in response to the distributed queries. The results of the distributed queries can be assembled and returned to a client at reference numeral 610. The results can include content, such as data and tasks associated with such data.

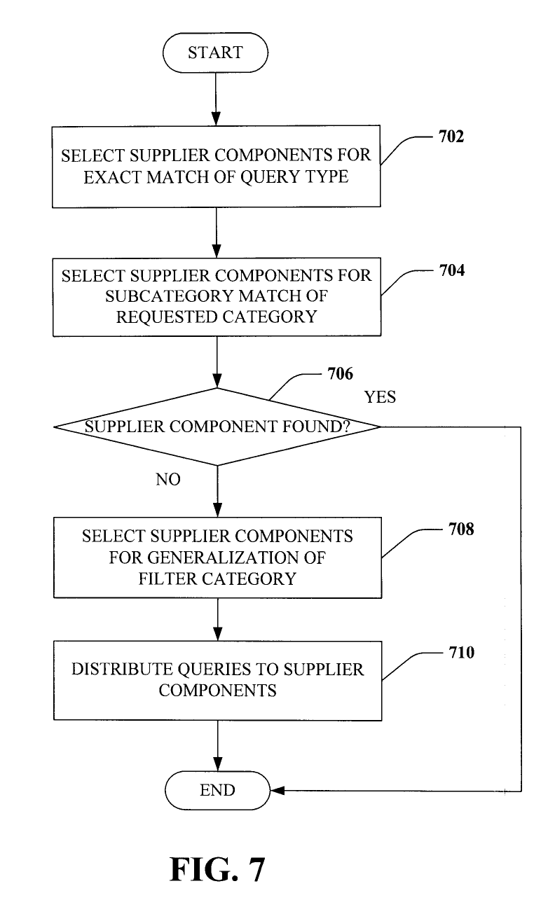

Referring now to FIG. 7, a methodology for generating a set of queries or requests for content from supplier components is illustrated. The client query can specify the category of requested data and context including the content category used to filter results and the actual filter data. Query type can be defined by the combination of requested category and filter category. Each supplier component can support one or more query types. At reference numeral 702, available supplier components that support query types that are an exact match of the client query type are selected. An exact match indicates that the supplier component supports queries with the requested category and filter category of the client query.

Relevant query results can also be retrieved from supplier components that support query types where the requested category is a subcategory of the requested category of the client query. For example, if the requested category is Email Messages, supplier components that support queries with a requested category of Hotmail Email Message, a subcategory of Email Messages, can provide relevant query results. At reference numeral 704, supplier components are identified that support queries in which the requested category is a subcategory of the requested category of the client query and the filter categories are identical. To identify such supplier components, a determination can be made as to whether the requested category of the client query includes any subcategories. If there are available subcategories, supplier components that support queries for any of the subcategories of the requested category and the filter category of the master query are identified.

A determination is made at reference numeral 706 as to whether any supplier components have been identified at either reference numeral 702 or 704 that support the client query. If at least one supplier component has been found, the process terminates. If no supplier components have been found, the filter category can be generalized to search for alternative supplier components. To identify alternative supplier components, a determination is made as to whether the filter category of the client query is a subcategory of another content category. If the client query filter category is a subcategory, supplier components that support queries for any of the categories for which the filter category is a subcategory are identified at reference numeral 708. For example, if the client query requests email messages filtered based upon Business Contacts. Supplier components that support queries of email messages filtered based upon Contacts, where a Business Contact is a subcategory of Contact, are identified. At reference numeral 710, queries can be distributed to the identified supplier components.

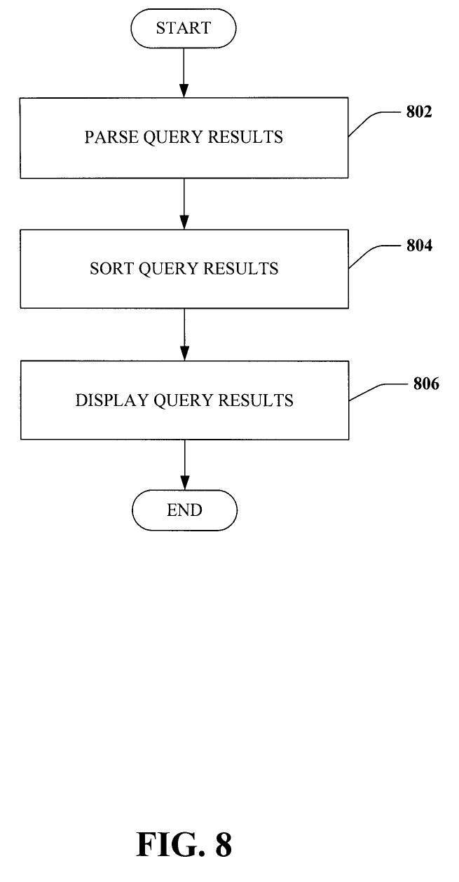

Referring now to FIG. 8, a methodology for preparing query results for display is illustrated. At reference numeral 802, query results can be parsed and relevant data can be extracted and provided to the client. The client can request particular data from the query results. At reference numeral 804, the list of query results can be sorted. The list of query results can be sorted based upon any field or data within the query results. Content categories can include a sort property that defines the basis on which query results of a particular category are to be sorted. The client can also specify the data on which the sort can be based as well as the sorting criteria, such as numerical or alphabetical order. The query results can be displayed at reference numeral 806. The query results can be displayed based upon display properties associated with content categories.

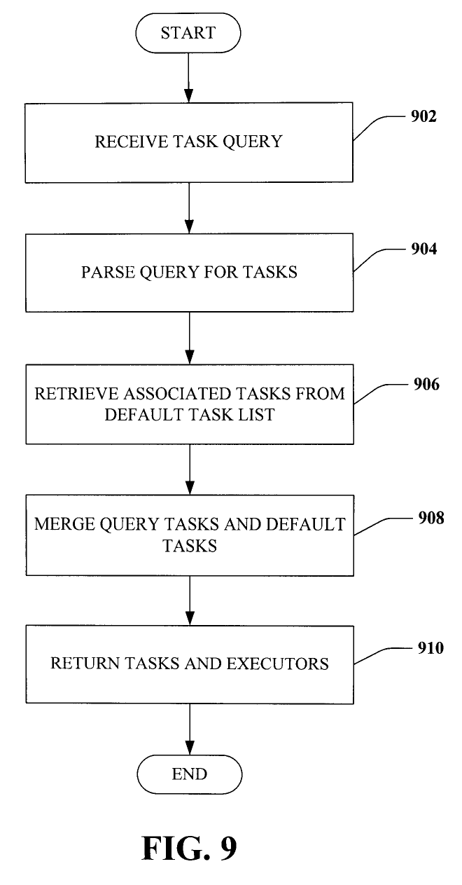

Referring now to FIG. 9, a methodology for retrieving task information is illustrated. At reference numeral 902, a query to retrieve task information related to an item within a set of query results is received. The query result item can be parsed to retrieve any task data within the query result item at reference numeral 904. Additional task information can be retrieved from a default task list at reference numeral 906. The default task list can include tasks that are generally associated with a specific content category. Task data retrieved from the query result item and task data from the default task list can be merged and prioritized at reference numeral 908. Typically, task data specifically associated with the query result item is prioritized over task data form the default task list that is generally associated with the category of the query result item. At reference numeral 910, the task data including tasks and task executors can be returned to the client.

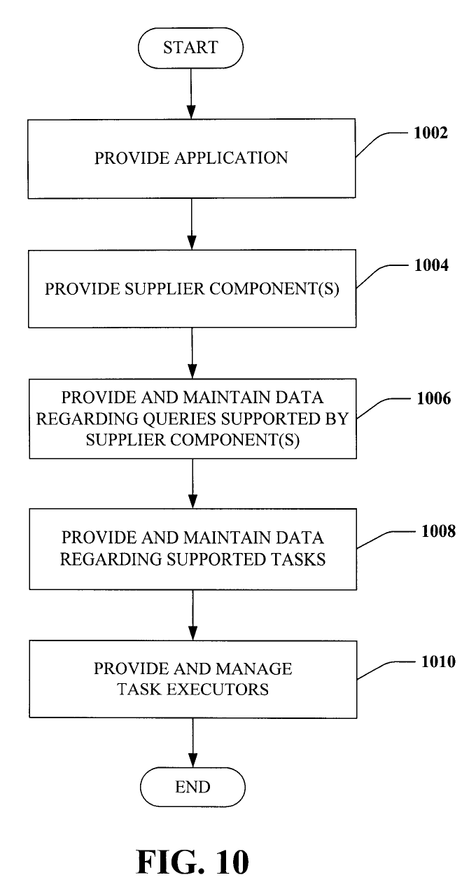

Referring now to FIG. 10, a methodology for sharing content from a new application is illustrated. At reference numeral 1002, a new application is provided. One or more supplier components capable of retrieving content from the application can be provided at reference numeral 1004. Information regarding the types of queries supported by the supplier components can be received and maintained at reference numeral 1006. Information regarding tasks associated with the application can be provided and maintained at 1008. At reference numeral 1010, one or more task executors capable of executing a task can be provided and managed.

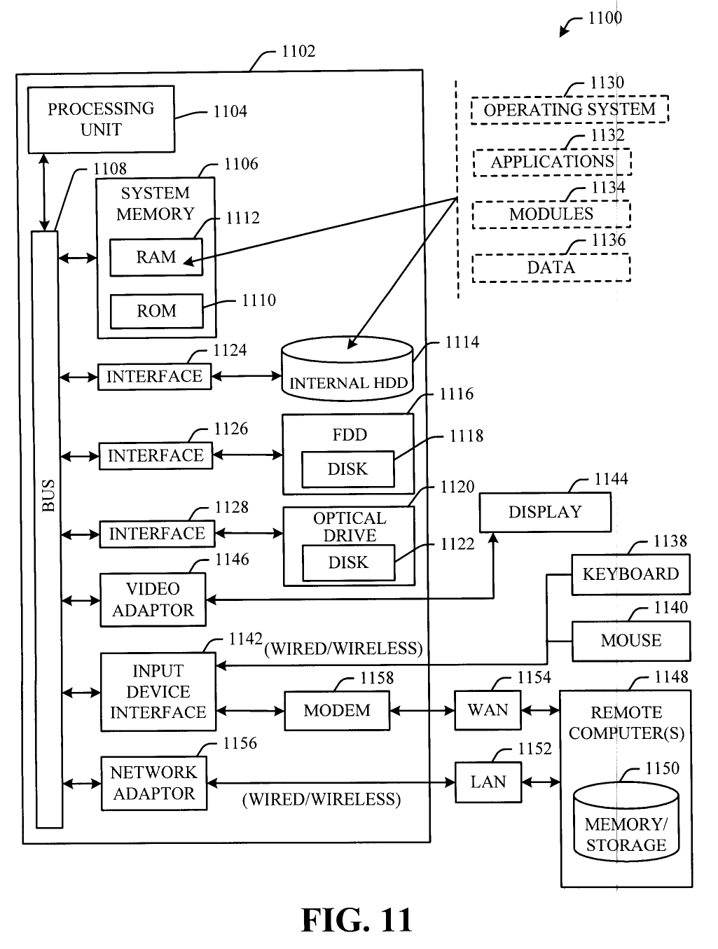

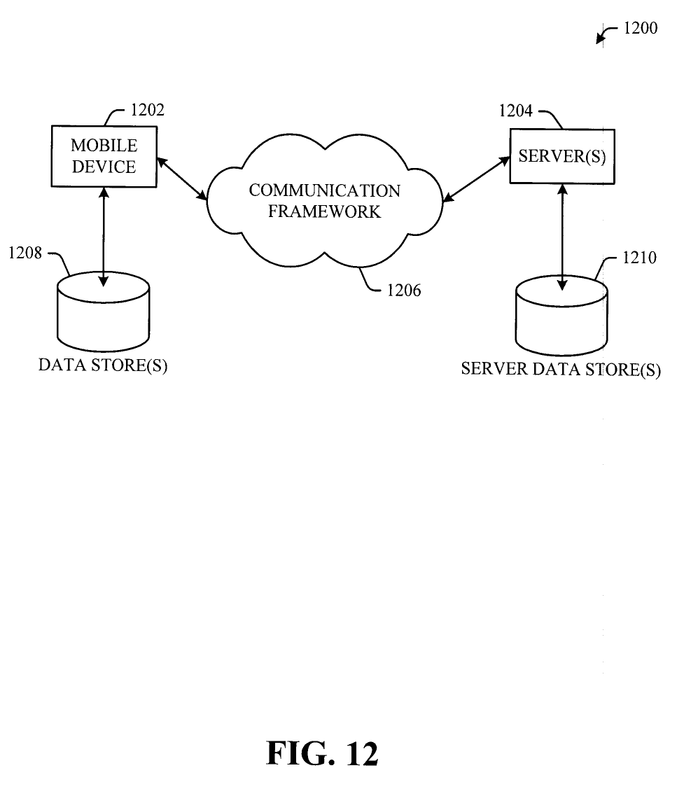

In order to provide a context for the various aspects of the disclosed subject matter, FIGS. 11 and 12 as well as the following discussion are intended to provide a brief, general description of a suitable environment in which the various aspects of the disclosed subject matter may be implemented. While the subject matter has been described above in the general context of computer-executable instructions of a computer program that runs on a mobile device including a smartphone, PDA, computer and/or computers, those skilled in the art will recognize that the innovations described herein also may be implemented in combination with other program modules or software applications. Generally, program modules include routines, programs, components, data structures, etc. that perform particular tasks and/or implement particular abstract data types. Moreover, those skilled in the art will appreciate that the inventive methods may be practiced with other computer system configurations, including single-processor or multiprocessor computer systems, mini-computing devices, mainframe computers, as well as personal computers, other hand-held computing devices (e.g., PDA, phone, watch . . . ), microprocessor-based or programmable consumer or industrial electronics, and the like. The illustrated aspects may also be practiced in distributed computing environments where tasks are performed by remote processing devices that are linked through a communications network. However, some, if not all aspects of the subject matter described herein can be practiced on stand-alone computers, including mobile devices. In a distributed computing environment, program modules may be located in both local and remote memory storage devices.

With reference again to FIG. 11, the exemplary environment 1100 for implementing various aspects of the embodiments includes a mobile device or computer 1102, the computer 1102 including a processing unit 1104, a system memory 1106 and a system bus 1108. The system bus 1108 couples system components including, but not limited to, the system memory 1106 to the processing unit 1104. The processing unit 1104 can be any of various commercially available processors. Dual microprocessors and other multi-processor architectures may also be employed as the processing unit 1104.

The system memory 1106 includes read-only memory (ROM) 1110 and random access memory (RAM) 1112. A basic input/output system (BIOS) is stored in a non-volatile memory 1110 such as ROM, EPROM, EEPROM, which BIOS contains the basic routines that help to transfer information between elements within the computer 1102, such as during start-up. The RAM 1112 can also include a high-speed RAM such as static RAM for caching data.

The computer or mobile device 1102 further includes an internal hard disk drive (HDD) 1114 (e.g., EIDE, SATA), which internal hard disk drive 1114 may also be configured for external use in a suitable chassis (not shown), a magnetic floppy disk drive (FDD) 1116, (e.g., to read from or write to a removable diskette 1118) and an optical disk drive 1120, (e.g., reading a CD-ROM disk 1122 or, to read from or write to other high capacity optical media such as the DVD). The hard disk drive 1114, magnetic disk drive 1116 and optical disk drive 1120 can be connected to the system bus 1108 by a hard disk drive interface 1124, a magnetic disk drive interface 1126 and an optical drive interface 1128, respectively. The interface 1124 for external drive implementations includes at least one or both of Universal Serial Bus (USB) and IEEE 1194 interface technologies. Other external drive connection technologies are within contemplation of the subject systems and methods.

The drives and their associated computer-readable media provide nonvolatile storage of data, data structures, computer-executable instructions, and so forth. For the computer 1102, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the exemplary operating environment, and further, that any such media may contain computer-executable instructions for performing the methods for the embodiments of the data management system described herein.

A number of program modules can be stored in the drives and RAM 1112, including an operating system 1130, one or more application programs 1132, other program modules 1134 and program data 1136. All or portions of the operating system, applications, modules, and/or data can also be cached in the RAM 1112. It is appreciated that the systems and methods can be implemented with various commercially available operating systems or combinations of operating systems.

A user can enter commands and information into the computer 1102 through one or more wired/wireless input devices, e.g. a keyboard 1138 and a pointing device, such as a mouse 1140. Other input devices (not shown) may include a microphone, an IR remote control, a joystick, a game pad, a stylus pen, touch screen, or the like. These and other input devices are often connected to the processing unit 1104 through an input device interface 1142 that is coupled to the system bus 1108, but can be connected by other interfaces, such as a parallel port, an IEEE 1194 serial port, a game port, a USB port, an IR interface, etc. A display device 1144 can be used to provide a set of group items to a user. The display devices can be connected to the system bus 1108 via an interface, such as a video adapter 1146.

The mobile device or computer 1102 may operate in a networked environment using logical connections via wired and/or wireless communications to one or more remote computers, such as a remote computer(s) 1148. The remote computer(s) 1148 can be a workstation, a server computer, a router, a personal computer, portable computer, microprocessor-based entertainment appliance, a peer device or other common network node, and typically includes many or all of the elements described relative to the computer 1102, although, for purposes of brevity, only a memory/storage device 1150 is illustrated. The logical connections depicted include wired/wireless connectivity to a local area network (LAN) 1152 and/or larger networks, e.g. a wide area network (WAN) 1154. Such LAN and WAN networking environments are commonplace in offices and companies, and facilitate enterprise-wide computer networks, such as intranets, all of which may connect to a global communications network, e.g., the Internet.

When used in a LAN networking environment, the computer 1102 is connected to the local network 1152 through a wired and/or wireless communication network interface or adapter 1156. The adaptor 1156 may facilitate wired or wireless communication to the LAN 1152, which may also include a wireless access point disposed thereon for communicating with the wireless adaptor 1156.

When used in a WAN networking environment, the computer 1102 can include a modem 1158, or is connected to a communications server on the WAN 1154, or has other means for establishing communications over the WAN 1154, such as by way of the Internet. The modem 1158, which can be internal or external and a wired or wireless device, is connected to the system bus 1108 via the serial port interface 1142. In a networked environment, program modules depicted relative to the computer 1102, or portions thereof, can be stored in the remote memory/storage device 1150. It will be appreciated that the network connections shown are exemplary and other means of establishing a communications link between the computers can be used.

The computer 1102 is operable to communicate with any wireless devices or entities operatively disposed in wireless communication, e.g., a printer, scanner, desktop and/or portable computer, PDA, communications satellite, any piece of equipment or location associated with a wirelessly detectable tag (e.g. a kiosk, news stand, restroom), and telephone. The wireless devices or entities include at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10BaseT wired Ethernet networks used in many offices.

FIG. 12 is a schematic block diagram of a sample environment 1200 with which the systems and methods described herein can interact. The system 1200 includes one or more mobile device(s) 1202. The mobile device(s) 1202 can be hardware and/or software (e.g. threads, processes, computing devices). The system 1200 also includes one or more server(s) 1204. Thus, system 1200 can correspond to a two-tier client server model or a multi-tier model (e.g., client, middle tier server, data server), amongst other models. The server(s) 1204 can also be hardware and/or software (e.g., threads, processes, computing devices). One possible communication between a mobile device 1202 and a server 1204 may be in the form of a data packet adapted to be transmitted between two or more computer processes. The system 1200 includes a communication framework 1206 that can be employed to facilitate communications between the mobile device(s) 1202 and the server(s) 1204. The mobile device(s) 1202 can be operably connected to or include one or more data store(s) 1208 that can be employed to store information local to the mobile device(s) 1202. Similarly, the server(s) 1204 are operably connected to one or more server data store(s) 1210 that can be employed to store information local to the servers 1204.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications and variations that fall within the spirit and scope of the appended claims. Furthermore, to the extent that the terms “includes,” “has” or “having” are used in either the detailed description or the claims, such terms are intended to be inclusive in a manner similar to the term “comprising” as “comprising” is interpreted when employed as a transitional word in a claim.

What is claimed is:

1. A system for facilitating sharing of content between a plurality of applications and a user interface for a mobile device, comprising:
a supplier manager component that manages a plurality of supplier components that access content of the plurality of applications, the supplier manager component selects a supplier component from the plurality of supplier components for a query; and
a query manager component that receives the query from the user interface and returns a query result list that includes content provided by the selected supplier component.

2. The system of claim 1, the query includes a context filter, the query result list is based at least in part on the context filter.

3. The system of claim 1, further comprising a query distributor component that generates a supplier query based at least in part upon the query from the user interface and distributes the supplier query to the selected supplier component.

4. The system of claim 1, the query result list includes data and at least one associated task.

5. The system of claim 1, further comprising:
a content category registration component that maintains at least one content category that represents a class of data.

6. The system of claim 5, further comprising:
a task component that associates at least one task with the at least one content category.

7. The system of claim 6, further comprising:
a task executor component that manages a task executor that executes the at least one task.

8. The system of claim 1, further comprising:
a parser component that parses the query result list and returns data to the user interface.

9. The system of claim 1, further comprising:
a sorter component that arranges the query result list based at least in part upon a sort property associated with a content category and returns the sorted query result list to the user interface.

10. A method for facilitating provision of content from a plurality of applications to a user interface in a mobile device, comprising:
receiving a query that includes a requested content category and a context filter;
determining a content supplier based at least in part on the requested content category;
querying the content supplier;
receiving query results from the content supplier; and
returning the query results to the user interface.

11. The method of claim 10, the query results provided by the content supplier are of the requested content category.

12. The method of claim 10, the query results provided by the content supplier are of a subcategory of the requested content category.

13. The method of claim 10, the content supplier utilizes a generalization of the context filter to provide the query results.

14. The method of claim 10, further comprising:
sorting the query results based upon a sort property of the requested content category.

15. The method of claim 10, further comprising:
displaying the query results based upon a display property of the requested content category.

16. The method of claim 10, further comprising:
parsing the query results; and
providing data parsed from the query results to the user interface.

17. A system for providing content from at least one software application, comprising:
means for registering a supplier component that retrieves query results from the at least one software application;
means for maintaining a content category;
means for registering a task provided by the at least one software application, the task is associated with the content category; and
means for managing at least one task executor provided by the at least one software application associated with the task.

18. The system of claim 17, further comprising:
means for receiving a query from a client;
means for generating at least one supplier query based upon the client query;
means for distributing the at least one supplier query to the supplier component;
means for obtaining query results; and
means for returning query results to the client.

19. The system of claim 18, further comprising:
means for retrieving data from the query results; and
means for providing the retrieved data to the client.

20. The system of claim 17, further comprising:
means for sorting the query results and
means for displaying the query results.
